(19) United States
(12) Patent Application Publication
(10) Pub. No.: US 2022/0147343 A1
(43) Pub. Date: May 12, 2022

(54) TRANISTIONARY FIRMWARE PACKAGES

(71) Applicant: Hewlett-Packard Development Company, L.P., Spring, TX (US)

(72) Inventors: Yi-Fan Hsia, Taipei City (TW); Heng-Fu Chang, Taipei City (TW); Hung Lung Chen, Taipei City (TW)

(73) Assignee: Hewlett-Packard Development Company, L.P., Spring, TX (US)

(21) Appl. No.: 17/419,392

(22) PCT Filed: Mar. 11, 2019
(86) PCT No.: PCT/US2019/021693

§ 371 Date: Jun. 29, 2021

(51) Int. Cl. G06F 8/654; G06F 8/61; G06F 9/4401

(52) U.S. Cl. CPC G06F 8/654; G06F 9/4403; G06F 8/61

(57) ABSTRACT

In an example implementation according to aspects of the present disclosure, a system comprising a memory and a controller coupled to the memory. The controller receives a transitionary firmware package. The controller extracts a transitionary firmware from the transitionary firmware package. The controller writes the transitionary firmware to memory, wherein the transitionary firmware comprises a reduced functionality for each of a set of central processing units. The controller identifies the CPU currently installed in the system and determines a full featured firmware corresponding to that CPU. The controller writes the full featured firmware to the memory.

### BACKGROUND

Firmware packages provide low level software support fora central processing unit (CPU) or a family of CPUs. The firmware packages implement functionality corresponding to the CPU installed in a computer system.

### BRIEF DESCRIPTION OF THE DRAWINGS

FIG. 1 is a block diagram illustrating a transitionary firmware packages, according to an example;

FIG. 2 is a diagram illustrating a relationship between actors and actions for transitionary firmware packages, according to another example of the present disclosure;

FIG. 3 is a block diagram illustrating the layout of a transitionary firmware package according to an example;

FIG. 4 is a flow diagram illustrating a method to apply transitionary firmware package, according to an example; and

FIG. 5 is a computing device for supporting transitionary firmware package, according to an example.

### DETAILED DESCRIPTION

As part of a computer system platform firmware packages, also called BIOS packages, provide support for low level device interfaces. The firmware provides support for particular central processing units (CPUs) that are compatible for the computer system. The CPU support within the firmware allows a user to physically upgrade the CPU to a different CPU and the computer system will boot properly. Computer system platforms with long lifespans may physically support a wide number of interchangeable CPUs with different architectures. System integrators implement the firmware in an addressable memory footprint of limited size. Often all of the support required for all compatible CPUs for a computer system platform does not fit in the limited size footprint. In the event that a CPU is physically installed into a computer system without the appropriate support in the firmware, the computer system would fail to boot. Described herein is a system, a method and a computer readable medium for supporting transitionary firmware packages which would allow for firmware support for a large family of CPUs on a single computer system platform.

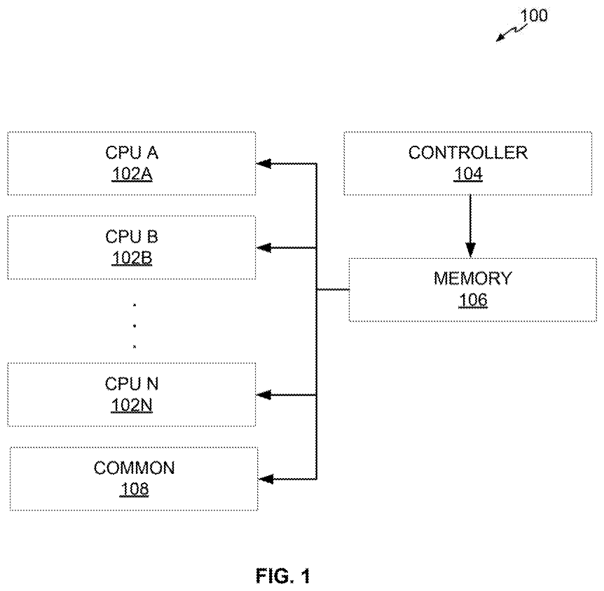

FIG. 1 is a block diagram illustrating a system 100 to support transitionary firmware packages, according to an example. The system 100 may include a controller 104. The controller 104 may be implemented as the host CPU of the system. Upon boot of a system 100, the controller 104 looks to a memory 106 for instructions to start the system. The memory 106 may be flash read only memory (flash ROM) containing boot instructions and device drivers. In some implementations the memory 104 may host a basic input/output system (BIOS) or universal extendable firmware interface (UEFI) image. The memory 106 may include CPU specific information required for the CPU to continue booting the system 100. In the system, the memory 106 may include instructions specific to a set of CPUs 102A, 102B, 102N. The memory 106 may include a common 108 component. The common 108 component may include functional code that is executable on the system 100 during boot regardless of which of the CPUs in the set of CPUs 102A, 102B, and 102N are installed. The common 108 component may be of reduced functionality in order to conserve addressable memory space in the memory 106 so that the set of CPUs 102A, 102B, and 102N may include as many CPUs specific code entries as possible for the system 100. The common component 108 may omit redundant code and security code to facilitate more CPU specific instructions.

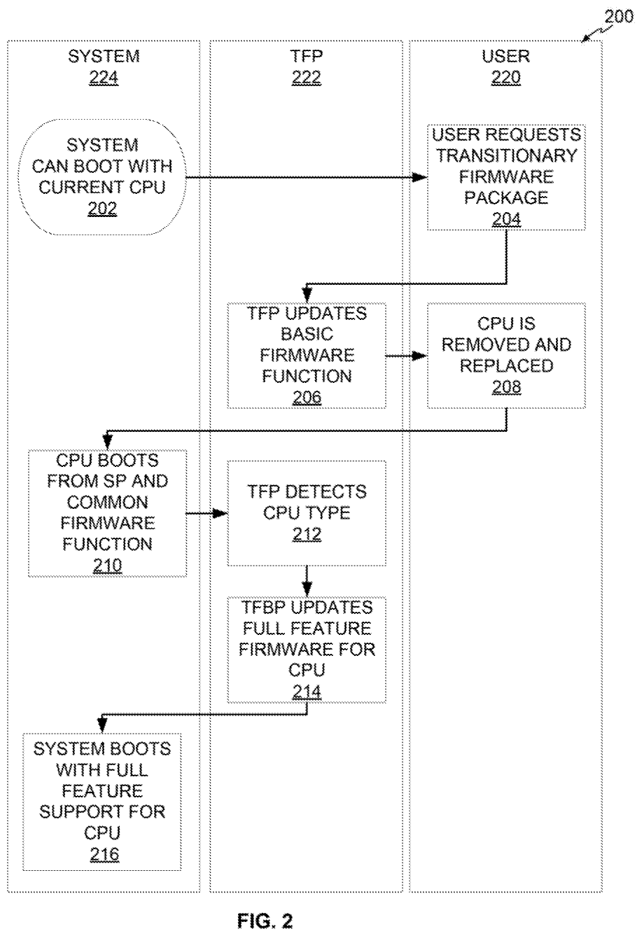

FIG. 2 is a diagram 200 illustrating a relationship between actors and actions for transitionary firmware packages, according to another example of the present disclosure. The diagram 200 includes actors including the system 224, the transitionary firmware package (TFP) 222 and a user 220. The system 224 may correspond to operations or instructions performed by the CPU that are not implemented within the transitionary firmware package 222.

At step 202, system can boot with current CPU. Step 202 may be a normal operational case for the system 224. In one implementation, step 202 may correspond with a system powering up at startup without any abnormal execution state.

At step 204, user requests a transitionary firmware package. A user 220 may request the installation of a transitionary firmware package. The request may be made through the manufacturer of the computer system. In most cases, the transitionary firmware package may be provided by the manufacturer of the computer system. The transitionary firmware package may include a transitionary firmware, one or more full function firmware for a set of CPUs supported by the system. Additionally, the transitionary firmware package may include additional code or software to execute within an operating system. For example, the transitionary firmware package may include additional executable files and dynamic link libraries to begin execution in Microsoft Windows® Operating System (Windows is a registered trademark of the Microsoft Corporation, Redmond Wash.).

At step 206, TFP updates basic firmware function. The transitionary firmware package executes a utility to flash a ROM with a transitionary firmware. As described in reference to FIG. 1, the transitionary firmware includes basic functionality for operation of the computer system, as well as multiple sets of code specific to the installed CPU.

At step 208, the CPU is removed and replaced. A user may remove a current CPU and replace the current CPU with a new CPU. The new CPU may include a common architecture with the current CPU. In some implementations, the current CPU and the new CPU may be in the same CPU “family” where the new CPU may be a new revision of the current CPU and may include architectural enhancements as well a new manufacturing lithography. While the current CPU and the new CPU are generationally different, they still may belong to the same CPU “family” as the core architecture between them remains the same.

At step 210, system boots from a security processor (SP) segment and the common segment of the transitionary firmware with the replaced CPU. The SP segment is the CPU unique section of the transitionary software that identifies the processor to the system. For example, on Advanced Micro Device (AMD) computing platforms, the SP segment of the transitionary firmware may correspond to a Platform Security Processor (PSP) firmware.

At step 212, TFP detects CPU type. Upon successful boot with the new CPU, execution is handed back to the TFP. The TFP may detect the CPU utilizing the SP segment executed from the transitionary firmware. In another implementation, the TFP may determine the CPU type utilizing software that extracts a CPUID field. The TFP then maps the CPU identity to a full featured firmware packaged as part of the TFP. The mapping may be implemented as a programmed conditional expression such as a ‘switch’ statement.

At step 214, TFP updates full feature firmware for new CPU. The TFP may utilize the same utility or function as used in the writing of the transitionary firmware to flash ROM to write the full feature firmware to flash ROM. In another implementation, the TFP may only write portions of the flash ROM based on the segments that differ between the full featured firmware image and the transitionary firmware previously written.

At step 216, system boots with full feature firmware support for replaced CPU. The computer system may be fully upgraded and operating within a normal state.

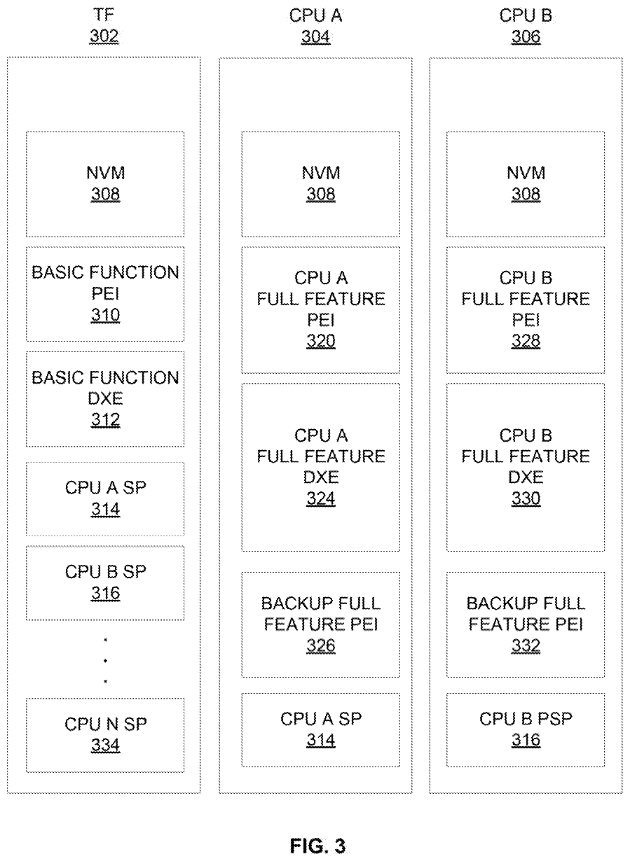

FIG. 3 is a block diagram illustrating the layout of a transitionary firmware package according to an example. FIG. 3 illustrates a comparative layouts for a transitionary firmware (TF) 302 memory allocation against full featured firmware memory allocations for CPU A 304 and CPU B 306. The memory allocation footprint for TF 302, CPU A 304 and CPU B 306 are the same.

A non-volatile memory NVM 308 segment may exist in the TF 302, CPU A 304 and CPU B firmware memory allocations. The NVM 308 may be utilized for storage of persistent values utilized during the boot sequence of the computer system.

The basic function pre-EFI initialization (PEI) 310 provides some basic computer startup functionality. Commonly, the basic function PEI 310 may initialize some permanent memory for the DXE phase and passes control of the system to the DXE. As the DXE phase is limited as well, instructions for the basic function PEI 310 may be limited.

The basic function driver execution environment (DXE) 312 may produce a set of boot services, runtime services, and DXE services. Commonly, the DXE is responsible for initializing the CPU, the chipset, and platform components. As the TFP 222 operates in a limited capacity, many functions for the system setup may be omitted.

The CPU A SP 314, CPU B SP 316 and CPU N SP 334 perform the security phase process within the boot sequence prior to the PEI phase or the DXE phase. The CPU A SP 314, CPU B SP 316 and CPU N SP 334 may include a secure boot key to validate the respective SP firmware image. If a corresponding SP for the installed system does not exist within the TF 302, CPU A 304 or CPU B 306, then the computer system may not exit the security phase of boot and therefore not start. The TF 302 may include any number of SP segments, as long as, the total of memory space allocated for the SP segments does not exceed the addressable memory space of the TF 302 (minus the other non-SP components).

The CPU A full feature PEI 320, the CPU A full feature DXE 324, the backup full feature PEI 326, the CPU B full feature PEI 328, CPU B full feature DXE 330 and the backup full feature PEI 332 all correspond to normal operational segments of the addressable memory space for their respective CPU implementations. Backup PEI Full feature PEI 326 and backup full feature PEI 332 correspond to CPU A full feature PEI 320 and CPU B full feature PEI 328 respectively. The backup PEI segments may be included for fault tolerance and to mitigate memory corruption.

Both CPU A 304 and CPU B 306 include only CPU ASP 314 and CPU B SP 316 respectively. As CPU A 304 and CPU B 306 are not addressable memory spaces for the transitionary firmware, any other SP segments may not be necessary for operation. Additionally addressable memory space from omitted SP segments may be recovered and utilized for full featured segments and backup segments for system robustness.

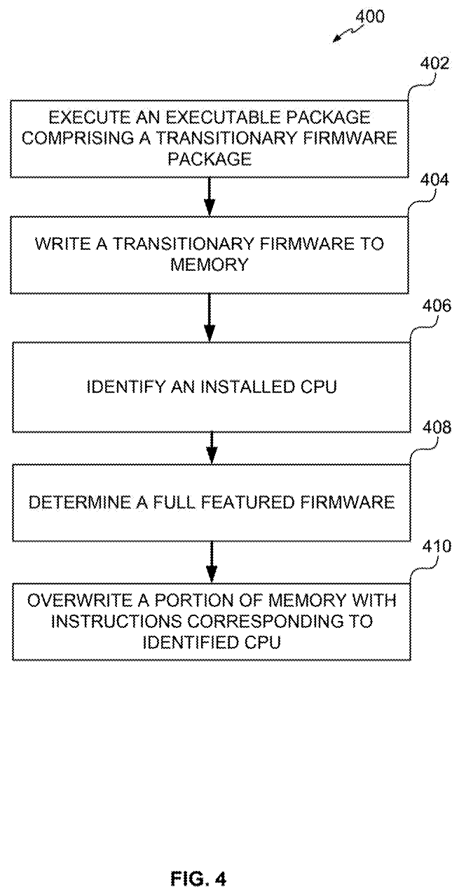

FIG. 4 is a flow diagram 400 illustrating a method to apply transitionary firmware package, according to an example.

At step 402, the controller executes an executable package comprising a TFP. As discussed previously, the executable package may include the TFP. TFP may include a transitionary firmware image, a number of full featured firmware images, and additional support logic for the execution, identification of a CPU type, and utility to write to flash ROM. The execution of the executable package may result in the computer system to be placed in a transitionary state wherein the TFP executes the included logic.

At step 404, the controller writes a transitionary firmware to memory. The controller, as instructed by the logic in the TFP, writes the transitionary firmware to a flash ROM. The transitionary firmware may include logic to complete low level boot processes by the computer system utilizing one of a set of supported CPUs.

At step 406, the controller identifies an installed CPU. The controller, through the TFP logic, identifies a CPU. The TFP may include code or utilities to identify the CPU through a CPUID.

At step 408, the controller determines a full featured firmware package. The controller, through the TFP logic, may map the corresponding full featured firmware to the CPUID. In another implementation, the TFP logic may evaluate conditional expressions such as a switch statement to identify the corresponding full featured firmware.

At step 410, the controller overwrites a portion of the memory with instructions corresponding to the identified CPU. The controller, through utility of the TFP writes to the flash ROM. The TFP may direct the utility to overwrite corresponding segments of the flash ROM pertinent to the identified CPU. In another implementation, the TFP may direct the utility to overwrite the entire addressable flash ROM with the full featured firmware corresponding to the identified CPU.

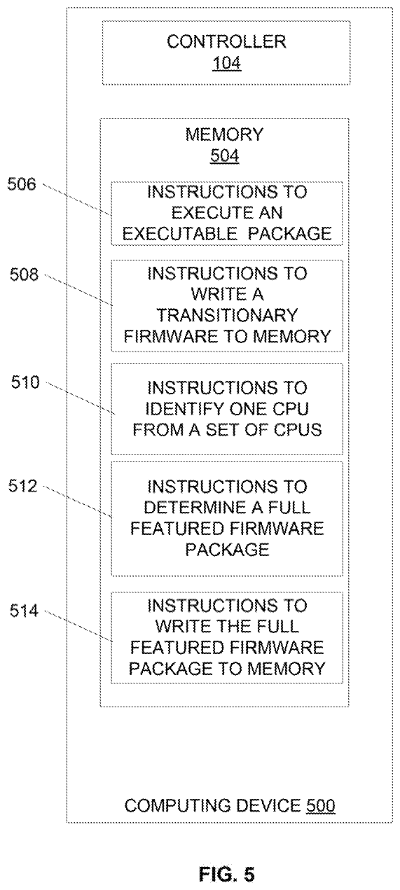

FIG. 5 is a computing device for supporting transitionary firmware package, according to an example. The computing device 500 depicts a controller 104 and a memory 504 and, as an example of the computing device 500 performing its operations, the memory 504 may include instructions 406-414 that are executable by the controller 104. The controller 104 may be synonymous with the processor found in common computing environments including but not limited to central processing units (CPUs). The memory 504 can be said to store program instructions that, when executed by controller 104, implement the components of the computing device 500. The executable program instructions stored in the memory 504 include, as an example, instructions to execute an executable package 506, instructions to write a transitionary firmware to memory 508, instructions to identify one CPU from a set of CPUs 510, instructions to determine a full featured firmware package 512 and instructions write the full featured firmware package to memory 514.

Memory 504 represents generally any number of memory components capable of storing instructions that can be executed by controller 104. Memory 504 is non-transitory in the sense that it does not encompass a transitory signal but instead is made up of at least one memory component configured to store the relevant instructions. As a result, the memory 504 may be a non-transitory computer-readable storage medium. Memory 504 may be implemented in a single device or distributed across devices. Likewise, controller 104 represents any number of processors capable of executing instructions stored by memory device 504. Controller 104 may be integrated in a single device or distributed across devices. Further, memory 504 may be fully or partially integrated in the same device as controller 104, or it may be separate but accessible to that device and controller 104.

In one example, the program instructions 506-514 can be part of an installation package that, when installed, can be executed by controller 104 to implement the components of the computing device 400. In this case, memory 404 may be a portable medium such as a CD, DVD, or flash drive, or a memory maintained by a server from which the installation package can be downloaded and installed. In another example, the program instructions may be part of an application or applications already installed. Here, memory 404 can include integrated memory such as a hard drive, solid state drive, or the like.

It is appreciated that examples described may include various components and features. It is also appreciated that numerous specific details are set forth to provide a thorough understanding of the examples. However, it is appreciated that the examples may be practiced without limitations to these specific details. In other instances, well known methods and structures may not be described in detail to avoid unnecessarily obscuring the description of the examples. Also, the examples may be used in combination with each other.

Reference in the specification to “an example” or similar language means that a particular feature, structure, or characteristic described in connection with the example is included in at least one example, but not necessarily in other examples. The various instances of the phrase “in one example” or similar phrases in various places in the specification are not necessarily all referring to the same example.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the scope of the disclosure. Thus, the present disclosure is not intended to be limited to the examples shown herein but is to be accorded the widest scope consistent with the principles and novel features disclosed herein.

What is claimed is:

1. A system comprising:
a memory;
a controller communicatively coupled to the memory to:
receive a transitionary firmware package;
extract a transitionary firmware from the transitionary firmware package;
write the transitionary firmware to the memory, wherein the transitionary firmware comprises a reduced functionality for each of a set of central processing units (CPUs);
identify one CPU from the set of CPUs, wherein the one CPU is installed in the system;
determine a full featured firmware from the transitionary firmware package corresponding to the one CPU from a set of full featured firmwares; and
write the full featured firmware to the memory.

2. The system of claim 1 wherein the transitionary firmware comprises a data footprint of a same addressable size as the full featured firmware.

3. The system of claim 1 wherein the set of CPUs comprise similar CPUs compatible with the system.

4. The system of claim 1 wherein the transitionary firmware comprises a set of instructions in isolated memory segments dedicated to supporting one of each of the set of CPUs.

5. The system of claim 4 wherein the transitionary firmware further comprises a second set of instructions in a common memory segment dedicated to supporting all of each of the set of CPUs.

6. A method comprising:
executing an executable package comprising the transitionary firmware package;
writing a transitionary firmware to a memory, wherein the transitionary firmware comprises a reduced functionality for each of a set of central processing units (CPUs);
identifying one CPU from the set of CPUs, wherein the one CPU is installed in a system;
determining a full featured firmware corresponding to the one CPU from a set of full featured firmwares; and
overwriting a portion of the memory with a set of instructions corresponding to the identified CPU, wherein the portion of memory comprises instructions irrelevant to the identified CPU.

7. The method of claim 6 wherein the transitionary firmware comprises a data footprint of a same addressable size as the full featured firmware package.

8. The method of claim 6 wherein the set of CPUs comprise similar CPUs compatible with the system.

9. The method of claim 6 wherein the transitionary firmware comprises a set of instructions in isolated memory segments dedicated to supporting one of each of the set of CPUs.

10. The method of claim 9 wherein the transitionary firmware further comprises a second set of instructions in a common memory segment dedicated to supporting all of each of the set of CPUs.

11. A computer readable medium comprising a memory having instructions stored thereon and a controller configured to perform, when executing the instructions to:
execute an executable package comprising the transitionary firmware package;
write a transitionary firmware to the memory, wherein the transitionary firmware comprises a reduced functionality for each of a set of central processing units (CPUs);
identify one CPU from the set of CPUs, wherein the one CPU is installed in a system;
determine a full featured firmware corresponding to the one CPU from a set of full featured firmwares; and
write the full featured firmware to the memory.

12. The computer readable medium of claim 11 wherein the transitionary firmware comprises a data footprint of a same addressable size as the full featured firmware package.

13. The computer readable medium of claim 11 wherein the set of CPUs comprise similar CPUs compatible with the system.

14. The computer readable medium of claim 11 wherein the transitionary firmware comprises a set of instructions in isolated memory segments dedicated to supporting one of each of the set of CPUs.

15. The computer readable medium of claim 11 wherein the transitionary firmware further comprises a second set of instructions in a common memory segment dedicated to supporting all of each of the set of CPUs.
